(19) United States
(12) Patent Application Publication
(10) Pub. No.: US 2018/0001538 A1
(43) Pub. Date: Jan. 4, 2018

(54) METHOD FOR MANUFACTURING BY STRETCH BLOW MOLDING OF A CONTAINER AT HIGH STRETCHING SPEED

(71) Applicant: SIDEL PARTICIPATIONS, Octeville-sur-mer (FR)

(72) Inventor: Mikael DERRIEN, Octeville-sur-mer (FR)

(21) Appl. No.: 15/637,784

(22) Filed: Jun. 29, 2017

(30) Foreign Application Priority Data
Jun. 29, 2016 (FR) 1656048

(51) Int. Cl. B29C 49/06; B29C 49/12; B29C 49/32; B29C 49/78; B29C 49/48

(52) U.S. Cl. CPC B29C 49/06; B29C 49/32; B29C 49/783; B29C 49/12; B29C 2049/1209; B29C 2049/1266; B29C 2049/129; B29C 2049/4846; B29C 2049/1257

(57) ABSTRACT

Disclosed is a method for manufacturing a container by stretch blow molding starting from a preform made of plastic material within a forming unit that includes: a mold that is provided with a side wall and a mold bottom having the impression, jointly, of the container; and a stretching rod that is mounted to move in translation in relation to the mold between an upper position and a lower position. The method includes: a pre-blow-molding phase during which a fluid with a pre-blow-molding pressure is injected into the preform, and the rod is moved from its upper position to its lower position with a maximum travel speed of greater than or equal to 2.5 m/s.

### BACKGROUND OF THE INVENTION

### Field of the Invention

The invention relates to the manufacturing of containers by stretch blow molding starting from blanks made of plastic material, such as polyethylene terephthalate (PET).

### Description of the Related Art

Whether it involves a preform or an intermediate container that has already undergone a preforming operation, a blank comprises a body, generally cylindrical for rotation, a neck that constitutes the rim of the container that is to be formed, and a bottom that closes the body opposite the neck.

The conventional manufacturing technique consists in inserting the blank, heated in advance to a temperature that is higher than the glass transition temperature of the material (approximately 80° C. in the case of PET), into a mold that is provided with a wall that defines a cavity having the impression of the container, and in injecting into the blank, via the neck, a fluid, such as a gas (generally air), under pressure to flatten the material against the wall of the mold. The forming comprises in general a pre-blow-molding phase, during which the fluid is injected at a relatively low pre-blow-molding pressure (ordinarily less than or equal to 15 bar), and a blow-molding phase, after the pre-blow-molding phase, during which the fluid is injected at a high blow-molding pressure (ordinarily greater than or equal to 25 bar), higher than the pre-blow-molding pressure.

Under the action of the pressure, the material that is softened by the heat forms a bubble that swells up and develops both in an axial direction, parallel to the main axis of the mold, and in a radial direction, perpendicular to the axis of the mold.

So as to prevent any offsetting of the container (which makes it possible to ensure a good distribution of the constituent material of the blank in the finished container), the axial stretching of the blank is forced by means of a rod that can move axially in the mold, with this rod comprising a distal end that pushes the bottom of the blank until flattening it against a mold bottom having the impression of the bottom of the container.

It is known to control the movement of the stretching rod by means of a magnetic device, cf. the international application WO2012/156614 (Sidel Participations).

It was demonstrated—cf., for example, the international application WO2008/081107 (Sidel Participations)—that the good forming of a container relies on a subtle equilibrium between various parameters including the temperature for heating the blanks, the stretching speed, the pressure of fluid injected into the blanks, and the times at which the pre-blow molding and the blow molding are controlled successively.

The application of new environmental standards incites the users of container manufacturing facilities to reduce their energy consumption. The manufacturers are to redouble their ingenuity for proposing solutions that make it possible to decrease the energy consumption while preserving the quality of the containers that are produced, so as to meet the expectations of consumers.

### SUMMARY OF THE INVENTION

The object of the invention is to propose a solution that extends in this direction and that makes possible substantial gains in terms of energy consumption, while preserving the quality of the containers.

For this purpose, there is proposed a method for manufacturing a container by stretch blow molding, starting from a preform made of plastic material within a forming unit that comprises:
A mold that is provided with a side wall and a mold bottom having the impression, jointly, of the container, and
A stretching rod that is mounted to move in translation in relation to the mold between an upper position in which the rod is separated from the mold bottom and a lower position in which the rod is adjacent to the mold bottom, with this method comprising:
A pre-blow-molding phase during which a fluid at a so-called pre-blow-molding pressure is injected into the preform and the rod is moved from its upper position to its lower position with a maximum travel speed that is greater than or equal to 2.5 m/s;
A blow-molding phase during which a fluid at a so-called blow-molding pressure, higher than the pre-blow-molding pressure, but less than or equal to 20 bar, is injected into the preform.

Various additional characteristics can be provided, by themselves or in combination. Thus:
The maximum speed can be maintained during the majority of the pre-blow-molding phase;
The maximum travel speed of the rod is advantageously on the order of 3 m/s.

### BRIEF DESCRIPTION OF THE DRAWINGS

Other objects and advantages of the invention will become evident from the description of an embodiment, provided below with reference to the accompanying drawings, in which:

FIG. 1 is a cutaway perspective view, showing a unit for forming containers;

FIG. 2 is a detail cutaway and perspective view, on a larger scale, of the forming unit of FIG. 1, according to the inset II;

FIG. 3 is a cutaway front view of the forming unit of FIG. 2;

FIG. 4, FIG. 5, and FIG. 6 are detail cutaway front views, illustrating the forming of a container starting from a preform;

FIG. 7 is a diagram that shows the change in pressure inside the blank based on time, during a complete forming cycle.

### DESCRIPTION OF THE PREFERRED EMBODIMENTS

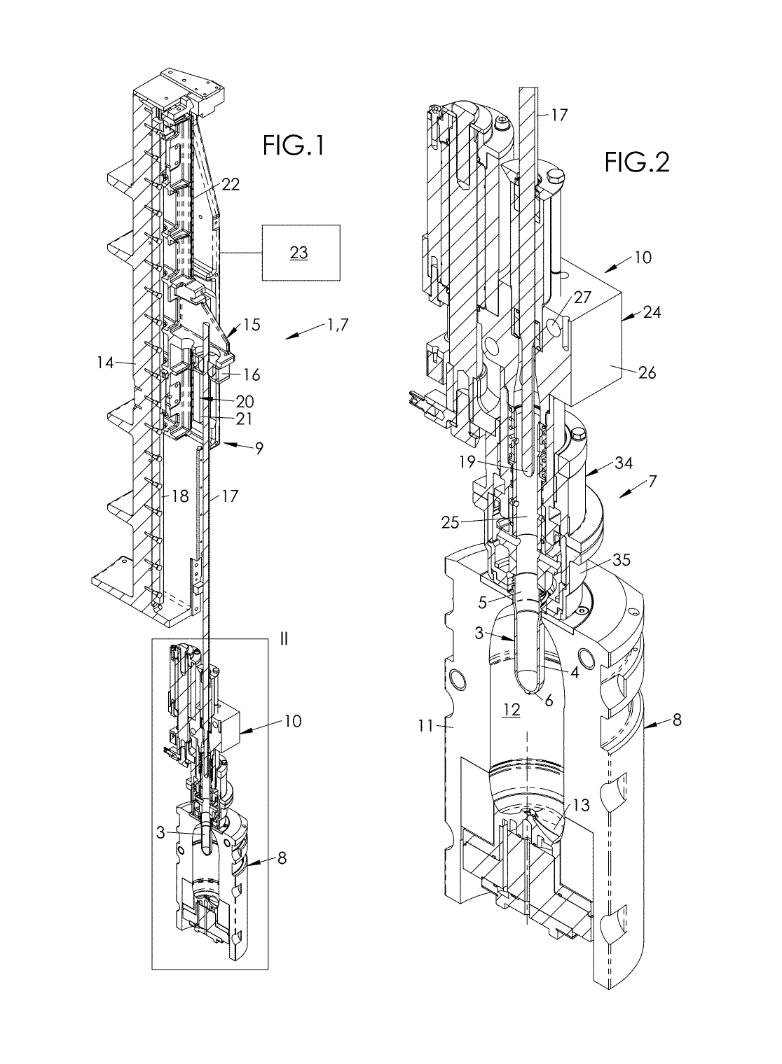

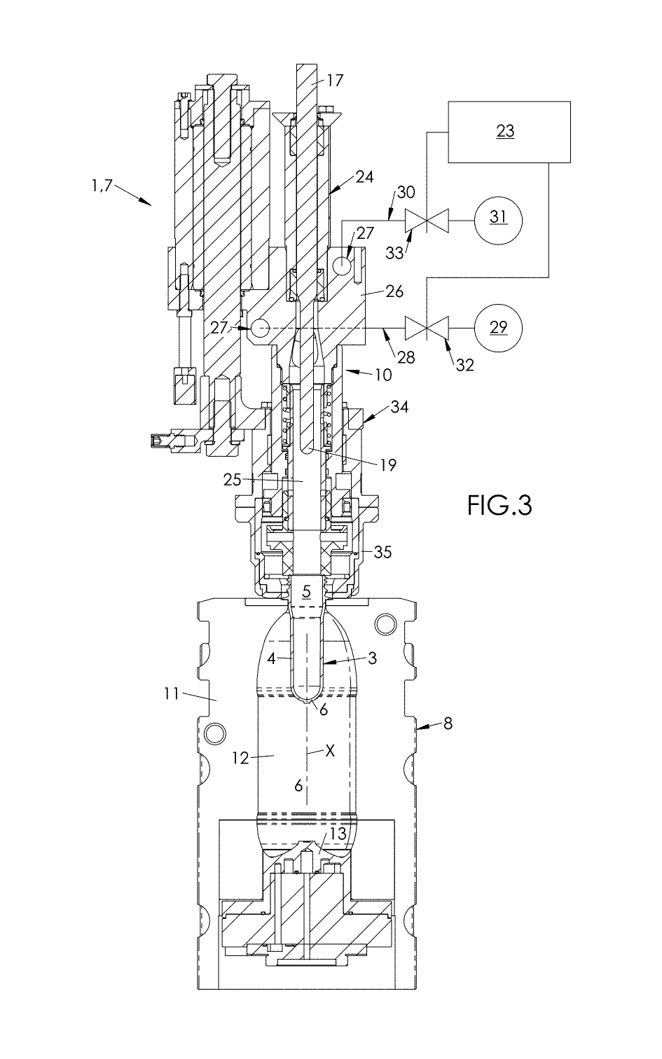

Partially shown in FIG. 1, FIG. 2, and FIG. 3 is a machine 1 for manufacturing containers 2 by stretch blow molding of blanks, in this case preforms 3, made of plastic material (such as PET) comprising an essentially cylindrical body 4, a neck 5 whose shape is definitive, and a hemispherical bottom 6 that closes the body 4 opposite the neck 5.

In practice, the machine 1 is equipped with a series of individual units 7 for forming by stretch blow molding, mounted on a carrousel (not shown) that is driven in rotation around a central axis. Each forming unit 7, such as the one shown in FIGS. 1 to 3, comprises a mold 8, a stretching unit 9, and an injection unit 10 that tops the mold 8.

The mold 8 is, for example, of the portfolio type and comprises two half-molds that are articulated around a common hinge and that open to make possible, successively, the removal of a container 2 that is formed and the insertion of a preform 3 that is to be formed, heated in advance in a heating unit (commonly referred to as “furnace”).

The mold 8 comprises a wall 11 that defines a cavity 12 having the impression of the container 2, essentially symmetrical in rotation around a main longitudinal axis X, and having, in a lower part, an opening in which is mounted a mold bottom 13 that, with the wall 11, completes the impression of the container 2.

The stretching unit 9 comprises a frame 14, attached to the carrousel of the machine 1, which extends vertically essentially perpendicular to the mold 8, and a movable apparatus 15 that includes a carriage 16 that carries a stretching rod 17. The carriage 16 is mounted to slide on a rail 18 that is integral with the frame 14, between
An upper position (FIG. 2) in which the rod 17 is completely brought out from the mold 8, a free lower end 19 of the rod 17 that is located in this configuration at a distance from the mold 8 that is greater than the height of the neck 5, in such a way as to make possible the removal of a formed container 2 and the insertion of a preform 3 that is to be blow molded.
A lower position (FIG. 6) in which the stretching rod 17 is accommodated in the mold 8 by coming into the immediate vicinity of the mold bottom 13, bringing about the sandwiching of the material of the container 2 between the free lower end 19 of the rod 17 and the mold bottom 13.

The stretching unit 9 is also equipped with an electromagnetic control device 20 for moving the carriage 16, which comprises:
A pair of motors 21, here of the electromagnetic type and consisting of two electromagnets that are each fixed to a side wall of the frame 14;
A pair of magnetic tracks 22 placed on the carriage 16, with each track 22 being formed by a series of permanent magnets with alternate polarity, placed opposite and at a short distance from each of the motors 21;
A control unit 23 (illustrated diagrammatically in FIG. 5), connected electrically to the motors 21 and programmed to deliver thereto an electrical control signal.

The injection unit 10 covers the mold 8 and has as its function to introduce, into the preform 3 that is heated in advance and suspended in the mold 8 by its neck 5, a pressurized fluid—in particular a gas such as air—to flatten the material against the wall 11 of the mold 8 and thus to impart to it the impression of the container 2.

The injection unit 10 comprises, in the first place, an injection block 24, attached to the carrousel perpendicular to the mold 8 and defining a fluid pipe 25 that is co-linear with the main axis X. The fluid pipe 25 has as its function to channel the fluid that is injected into the preform 3 to form the container 2 and to make possible the free sliding of the stretching rod 17.

According to an embodiment illustrated in the drawings, the injection block 24 comprises a housing 26 that is made of a rigid material and that is provided with at least one supply opening 27 that is connected:
By a pre-blow-molding pipe 28 to a source 29 of fluid (typically air) at a pre-blow-molding pressure PP that is relatively low (between 5 and 15 bar) (below, this source 29 will be referred to as a pre-blow-molding source 29),
And by a blow-molding pipe 30 to a source 31 of fluid (typically air) at a relatively high blow-molding pressure PS, and in any case higher than the pre-blow-molding pressure PP (below, this source 31 will be referred to as the blow-molding source 31). The blow-molding pressure PS is ordinarily on the order of 25 to 40 bar, but it will be explained how it is possible to reduce it without sacrificing the quality of the container 2.

According to a preferred embodiment, the pre-blow-molding pipe 28 and the blow-molding pipe 30 each comprise a respective solenoid valve 32, 33 connected to the control unit 23, in such a way that the latter controls the opening and the closing thereof to place successively the pre-blow-molding source 29 and the blow-molding source 31 in communication with the inside of the preform 3, making it possible to transform it into the container 2.

In the second place, the injection unit 10 comprises a movable apparatus 34 that is equipped with a hollow nozzle 35, also called a bell-nozzle, which is mounted in the housing 26 and is in fluid communication with the pipe 25. The movable apparatus 34 is, with the on-board nozzle 35, mounted in translation in relation to the mold 8 between an upper position, in which the nozzle 35 is separated from the mold 8 to make possible the removal of a formed container 2 and the insertion of a preform 3, and a lower position (FIG. 3), in which the nozzle 35 is in airtight contact with the mold 8 to make possible the forming of a container 2 starting from a preform 3.

The manufacturing of a container 2 is carried out as follows.

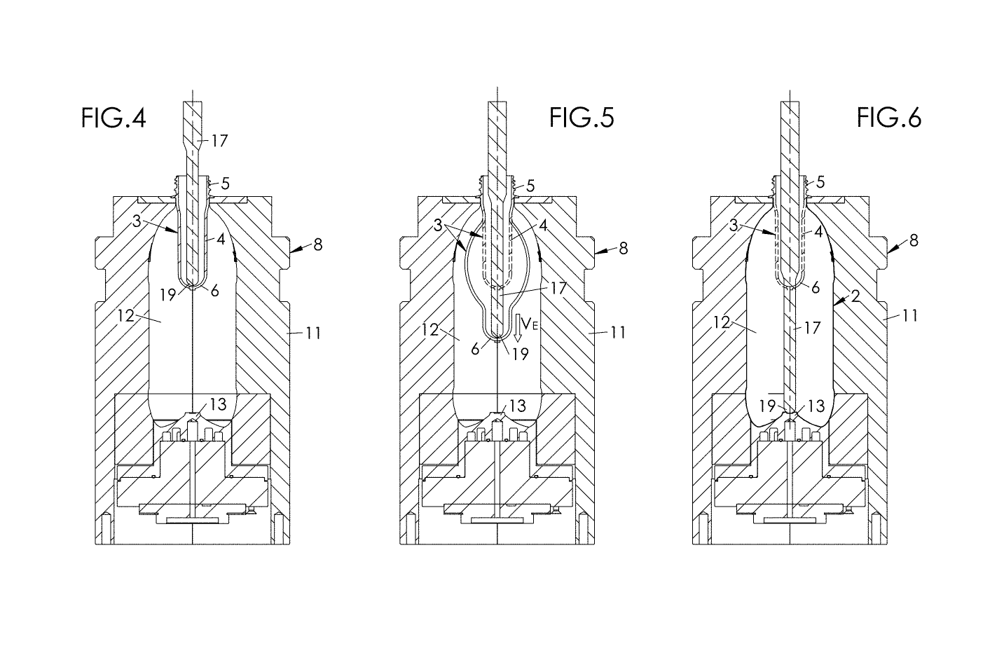

First of all, during a first phase, the preform 3, heated in advance to a temperature that is higher than the glass transition temperature of the material (approximately 80° C. in the case of PET), is inserted into the mold 8. When the preform 3 is in position, the mold 8 is closed again, and then the control unit 23 controls the movement of the carriage 16 (and therefore of the stretching rod 17) from its upper position to a starting position in which the free end 19 of the rod 17 comes into contact with the bottom 6 of the preform 3 (FIG. 4).

Then, during a second, so-called pre-blow-molding, phase, a fluid (normally air) at the pre-blow-molding pressure PP is injected into the preform 3 starting from the pre-blow-molding source 29 by controlling, at the initiative of the control unit 23, the opening of the solenoid valve 32.

At the same time, the stretching rod 17 is moved, at the command of the control unit 23, from its starting position to its lower position.

During the pre-blow-molding phase, the travel speed of the stretching rod 17, denoted V_{E}, is regulated in such a way as to maintain contact between the free end 19 of the rod 17 and the bottom 6 of the preform 3.

At the end of this pre-blow-molding phase (FIG. 6):
The container 2 is not completely formed, with several zones still not being in contact with the wall 11 because of the insufficient pressure;
The stretching rod 17, in its lower position, locally flattens the bottom 6 of the preform 3 against the mold bottom 13. In other words, the bottom 6 is sandwiched between the free end 19 of the stretching rod 17 and the mold bottom 13.

A third, so-called blow-molding, phase, then takes place, during which a fluid (typically air) at the blow-molding pressure PS is injected into the preform 3 starting from the blow-molding source 31 by controlling, at the initiative of the control unit 23, the opening of the solenoid valve 33.

The blow-molding pressure PS then flattens the material of the preform 3 firmly against the wall 11 of the mold 8 whose impression it takes, then forming the container 2 while being cooled (and therefore fixed) upon contact therewith.

A fourth, so-called degassing, phase follows at the end of the blow-molding phase, during which the inner volume of the thus formed container 2 is degassed by resetting it to ambient atmosphere (typically atmospheric pressure). The internal pressure of the container 2 then drops until asymptotically reaching the atmospheric pressure. Then, the carriage 16 (with the rod 17) is raised to the upper position, the mold 8 is opened, and the formed container 2 is removed to make possible the repetition of the cycle.

The duration of the pre-blow-molding phase, including the stretching, is on the order of (or less than) 200 ms.

The duration of the blow-molding phase is on the order of 700 ms to 1 s.

As for the degassing phase, it has a duration on the order of 400 to 500 ms.

In all, the forming cycle of a container 2 between the insertion of the preform 3 into the mold 8 and the removal of the formed container 2 from the mold 8 is on the order of (or less than) approximately 1.8 seconds.

Tests have made it possible to demonstrate that it is possible to realize substantial energy savings by decreasing the blow-molding pressure PS while increasing the stretching speed V_{E}, without sacrificing the quality of the container 2.

More specifically, it was noted that by combining:
A blow-molding pressure PS that is less than or equal to 20 bar; and
A stretching speed V_{E} that has at least temporarily a maximum that is greater than or equal to 2.5 m/s,
   it is possible to form a container 2 correctly by heating it in advance to a lower temperature, which makes it possible to decrease the power consumption in the area of the furnace.

An increase in the stretching speed V_{E} should in theory result in a significant reduction in the thickness of the material and therefore in a weakening of the container 2. However, it has been noted, surprisingly enough, that this is not at all the case. A plausible explanation is that the quick stretching of the preform 3 causes—on the molecular level, within the very material itself—a heating by friction that compensates for the reduction in the heating temperature and consequently makes possible a forming that is of at least as high quality as normal, because this self-heating of the material promotes better impression-taking of the material against the wall 11.

During the pre-blow-molding phase, the rod follows:
Firstly, an acceleration phase that makes it switch from a zero speed, corresponding to the stopping in the upper position, to a nominal value;
Secondly, a stabilization phase during which the travel speed of the rod 17 is essentially constant at its nominal value;
Thirdly, a deceleration phase during which the travel speed of the rod 17 decreases from the nominal value to a zero value corresponding to the stopping upon contact with the mold bottom 13.

According to a preferred embodiment, the nominal value corresponds to the maximum reached by the rod 17 during the entire stabilization phase. This stabilization phase advantageously extends during the majority of the pre-blow-molding phase. In other words, the maximum speed is maintained during the majority of the pre-blow-molding phase.

It is advantageous, furthermore, for the rod 17 to enter this stabilization phase even before the bottom 6 of the preform 3 docks. In other words, the rod 17 reaches its maximum speed even before entering into contact with the bottom 6 of the preform 3.

This makes it possible to accelerate the pre-blow-molding phase and therefore to realize time savings on the blow molding, thereby improving the quality of the container 2 that is produced.

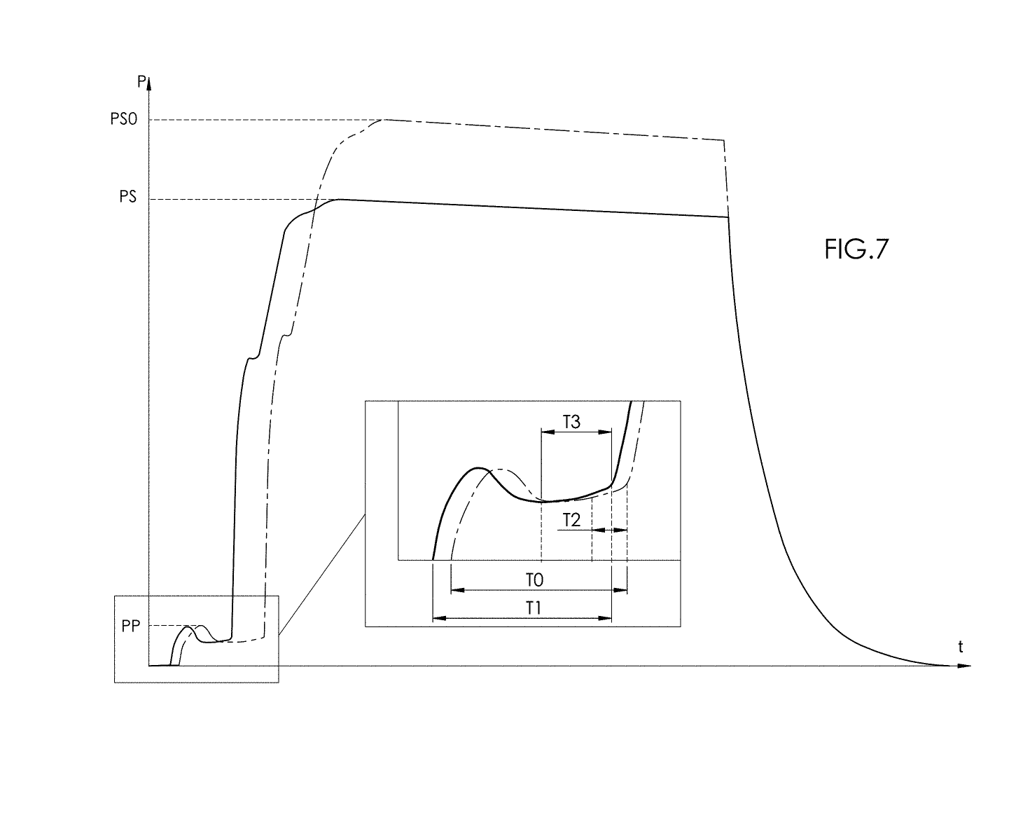

Two graphs are plotted in FIG. 7:
In dotted thin lines is a normal pressure curve, corresponding to a conventional heating temperature, a conventional stretching speed V_{E} (on the order of 2 m/s), and a blow-molding pressure PS0 on the order of 30 bar;
In solid bold lines is a pressure curve corresponding to a high stretching speed V_{E} (here, 3 m/s) and a comparatively lower blow-molding pressure PS (here, 20 bar).

The duration of the pre-blow molding, measured between the opening of the pre-blow-molding solenoid valve 32 and the opening of the blow-molding solenoid valve 33, is denoted T0 for the normal pressure curve (in dotted thin lines), and T1 for the pressure curve corresponding to the higher stretching speed (in solid bold lines).

Furthermore, the time interval separating the time when the rod 17 reaches its lower position and the end of the pre-blow molding is denoted T2 for the normal pressure curve (in dotted thin lines) and T3 for the pressure curve corresponding to the higher stretching speed (in solid bold lines).

In the two cases, the intervals T2 and T3 correspond to the radial swelling of the preform 3 under the action of the pre-blow-molding pressure. Below, “radial swelling times” refer to the intervals T2 and T3.

It is seen in the detail inset of FIG. 7 that the pre-blow-molding periods T0 and T1 are identical, but that the radial swelling times T2, T3 are different. More specifically, it appears that the radial swelling time T3 measured on the pressure curve corresponding to a high stretching speed is higher than the radial swelling time T2 measured on the pressure curve corresponding to a conventional stretching speed:

T3>T2

In the example illustrated in FIG. 7, the swelling time T3 is even on the order of double the swelling time T2:

T3≅2·T2

It is this elongation of the radial swelling time, a consequence of the increase in the stretching speed, which makes possible, i.a., a better impression-taking of the preform 3 at the end of the pre-blow molding and allows a lowering of the blow-molding pressure for an identical or higher container quality.

Another option allowed by the use of an increased stretching speed is the possibility of reducing the total duration of the pre-blow molding while preserving the radial swelling time (in this case, T3≅T2). The gain in time thus realized makes it possible to increase the duration of the blow molding.

In all of the cases, the contact time of the container 2 with the wall 11 is greater in the case of the high stretching speed, since the material enters into contact earlier with the former and is kept in contact longer.

Owing to the fast stretching and the combination of the optimization of the pre-blow-molding and blow-molding times, accompanied by the self-heating of the preform 3, containers 2 of a quality that is equivalent or better than those obtained with an ordinary stretching speed are obtained; in addition, the reduction of the blow-molding pressure, and, if necessary, a shorter heating bring about substantial savings in energy.

1. Method for manufacturing a container (2) by stretch blow molding starting from a preform (3) made of plastic material within a forming unit (7) that comprises:
A mold (8) that is provided with a side wall (11) and a mold bottom (13) having the impression, jointly, of the container (2), and
A stretching rod (17) that is mounted to move in translation in relation to the mold (8) between an upper position in which the rod (17) is separated from the mold bottom (13) and a lower position in which the rod (17) is adjacent to the mold bottom (13),
with this method comprising:
A pre-blow-molding phase during which a fluid at a so-called pre-blow-molding pressure (PP) is injected into the preform (3), and the rod (17) is moved from its upper position to its lower position;
A blow-molding phase during which a fluid at a so-called blow-molding pressure (PS), higher than the pre-blow-molding pressure (PP), is injected into the preform (3);
wherein:
The maximum travel speed of the rod (17) during the pre-blow-molding phase is greater than or equal to 2.5 m/s;
The blow-molding pressure (PS) is less than or equal to 20 bar.

2. Method according to claim 1, wherein the maximum speed is maintained for the majority of the pre-blow-molding phase.

3. Method according to claim 1, wherein the maximum travel speed of the rod (17) is on the order of 3 m/s.

4. Method according to claim 1, wherein the blow-molding pressure (PS) is on the order of 20 bar.

5. Method according to claim 2, wherein the maximum travel speed of the rod (17) is on the order of 3 m/s.

6. Method according to claim 2, wherein the blow-molding pressure (PS) is on the order of 20 bar.

7. Method according to claim 3, wherein the blow-molding pressure (PS) is on the order of 20 bar.

8. Method according to claim 5, wherein the blow-molding pressure (PS) is on the order of 20 bar.
